(19) United States
(12) Patent Application Publication
(10) Pub. No.: US 2013/0068406 A1
(43) Pub. Date: Mar. 21, 2013

(54) ELECTRIC SUNSHADE ASSEMBLY

(71) Applicant: PAUL LIN, Tainan City (TW)

(72) Inventor: PAUL LIN, Tainan City (TW)

(21) Appl. No.: 13/234,335

(22) Filed: Sep. 16, 2011

(51) Int. Cl. B60J 3/02

(52) U.S. Cl. 160/331

(57) ABSTRACT

An electric sunshade assembly includes a mounting unit including a rail seat that is formed with a slide groove, a sliding unit, a shade unit, and a driving mechanism. The sliding unit includes a gear rack extending slidably into the slide groove, and a guide block engaging fittingly and slidably the slide groove and connected to the gear rack. The shade unit includes a fabric shade hung from the rail seat, and having a hanging edge portion that has a stationary end coupled to the rail seat, and a movable end coupled co-movably to the guide block. The driving mechanism includes a pinion meshing with the gear rack, and driven rotatably to result in sliding movement of the gear rack, thereby driving the fabric shade to move between a contracted state and an extended state.

### BACKGROUND OF THE INVENTION

1. Field of the Invention

The invention relates to a sunshade assembly, more particularly to an electric sunshade assembly adapted to be mounted on a side window of an automobile.

2. Description of the Related Art

A conventional sunshade assembly for a side window of an automobile generally includes a horizontal rail seat, a shade member, and a plurality of hook members piercing through a top end portion of the shade member and hung slidably on the rail seat. In use, a lateral portion of the shade member is drawn leftwardly and rightwardly by a user for driving the hook members to slide along the rail seat, thereby moving the shade member between an extended state and a contracted state.

However, such an operation is required to be conducted manually by the user. That is, to reach the shade member, the user is required to be seated next to it. Since the automobile may include a plurality of side windows mounted respectively with a plurality of the conventional sunshade assemblies, the user has to be seated on different seats of the automobile for operating different shade members, thereby resulting in inconvenience.

### SUMMARY OF THE INVENTION

Therefore, the object of the present invention is to provide an electric sunshade assembly that is convenient to use.

Accordingly, an electric sunshade assembly of the present invention comprises a mounting unit, a sliding unit, a shade unit, and a driving mechanism. The mounting unit includes a rail seat having first and second ends that are opposite to each other in a longitudinal direction, and formed with a slide groove that extends therethrough from the first end to the second end. The sliding unit includes a gear rack that has an end extending slidably into the slide groove from the first end of the rail seat, and a guide block that engages fittingly and slidably the slide groove and that is connected to the end of the gear rack. The shade unit includes a fabric shade hung from the rail seat and disposed below the slide groove. The fabric shade has a hanging edge portion adjacent to the slide groove and extending in the longitudinal direction. The hanging edge portion has a stationary end coupled to the first end of the rail seat, and a movable end coupled co-movably to the guide block. The driving mechanism includes a pinion meshing rotatably with the gear rack, and a power unit for driving rotation of the pinion. The pinion is driven rotatably by the power unit to result in sliding movement of the end of the gear rack in the slide groove in the longitudinal direction, thereby driving the fabric shade to move relative to the rail seat between a contracted state, where the guide block is close to the first end of the rail seat, and an extended state, where the guide block is close to the second end of the rail seat.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary sectional view of a first preferred embodiment of an electric sunshade assembly according to the invention, illustrating a fabric shade at an extended state;

FIG. 2 is a fragmentary sectional view of the first preferred embodiment;

FIG. 3 is a fragmentary perspective view of a slide unit and a driving mechanism of the first preferred embodiment;

FIG. 4 is a view similar to FIG. 1, but illustrating the fabric shade at a contracted state;

FIG. 5 is a fragmentary perspective view of a second preferred embodiment of the electric sunshade assembly according to the invention; and

FIG. 6 is a fragmentary sectional view of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

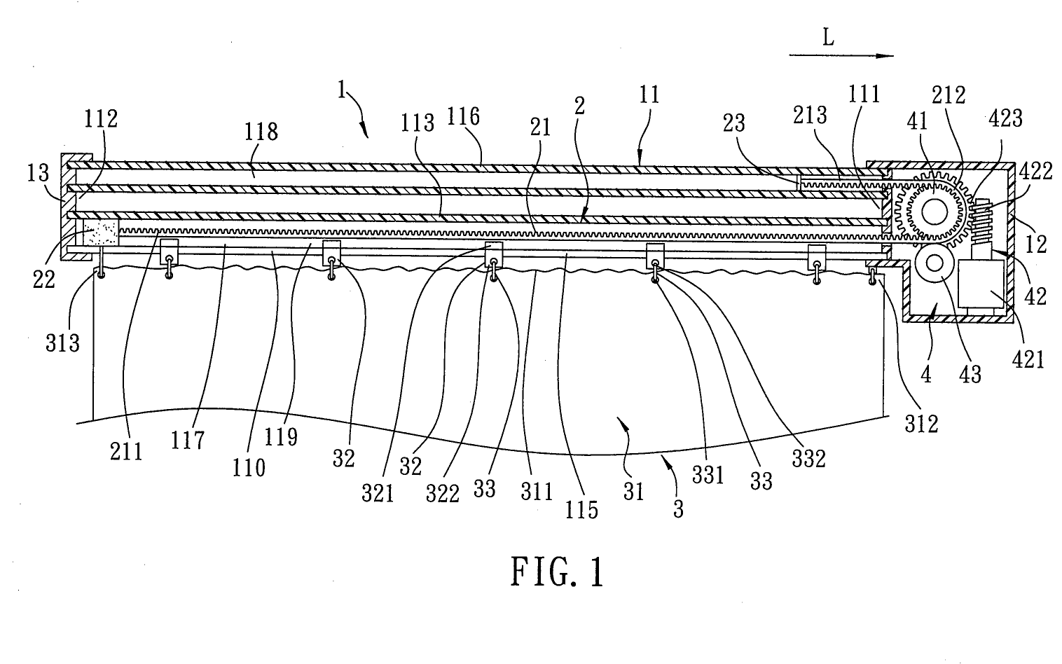

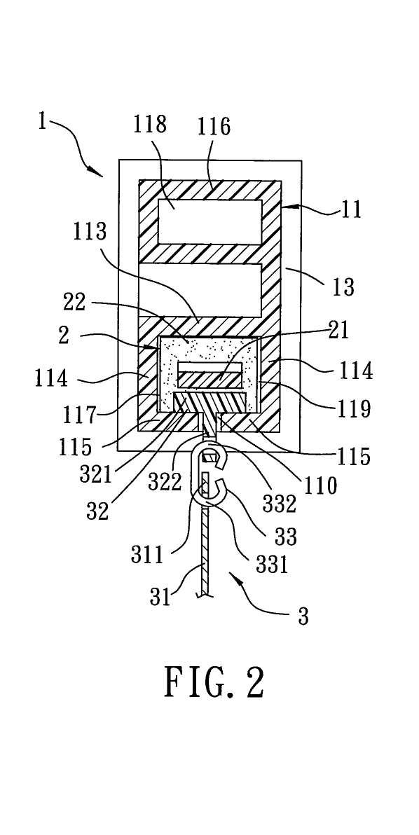

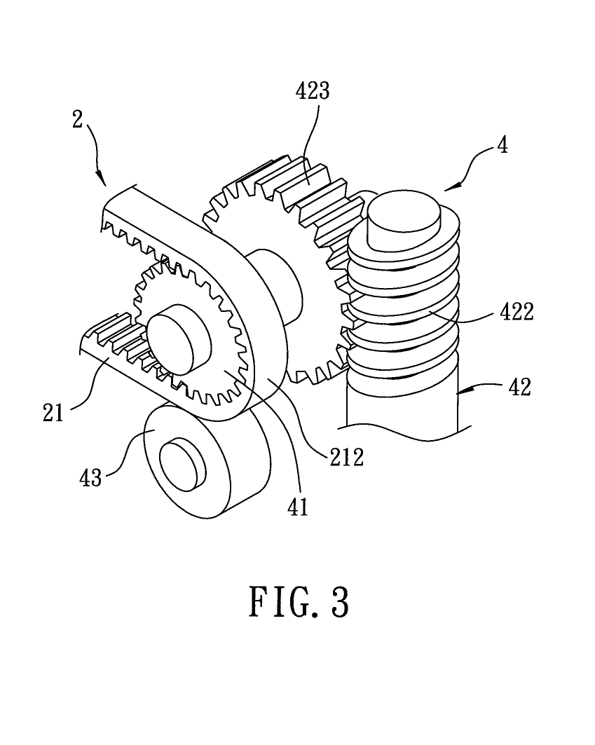

As shown in FIGS. 1 to 3, the first preferred embodiment of an electric sunshade assembly according to the present invention is adapted to be mounted on a side window of an automobile (not shown), and comprises a mounting unit 1, a slide unit 2, a shade unit 3, and a driving mechanism 4.

The mounting unit 1 includes a rail seat 11 having first and second ends 111, 112 that are opposite to each other in a longitudinal direction (L). In this embodiment, the rail seat 11 includes a horizontal base wall 113, a pair of side walls 114 extending downwardly and respectively from front and rear edges of the base wall 113, a pair of groove-defining walls 115 extending respectively from bottom edges of the side walls 114 toward each other, and a tubular wall 116 connected to a top end of the base wall 113. The groove-defining walls 115 cooperate with the base wall 113 and the side walls 114 to define a slide groove 117 thereamong. The slide groove 117 extends through the rail seat 11 from the first end 111 to the second end 112, and has a large groove portion 119 and a small groove portion 110. The small groove portion 110 is smaller than and communicates spatially with the large groove portion 119, and is disposed under the large groove portion 119 between distal edges of the groove-defining walls 115. The tubular wall 116 defines a through groove 118 parallel to and disposed over the slide groove 117. The mounting unit 1 further includes an end seat 12 coupled to the first end 111 of the rail seat 11, and an end cover 13 coupled to the second end 112 of the rail seat 11 for closing an end of the slide groove 117 at the second end 112 of the rail seat 11.

The slide unit 2 includes a gear rack 21, a guide block 22 and an engaging block 23. The gear rack 21 is configured as a flexible elongated rack that is formed with engaging teeth at one side and that extends slidably into the slide groove 117 from an opposite end thereof at the first end 111 of the rail seat 11, and has a head segment 211, a U-shaped middle segment 212 and a tail segment 213. The head segment 211 is disposed slidably in the slide groove 117 and has an end connected to the guide block 22. The middle segment 212 extends outwardly of the slide groove 117 from the head segment 211, and is bent toward and further extends into the through groove 118. The tail segment 213 extends from the middle segment 212 and is disposed slidably in the through groove 118. The guide block 22 engages fittingly and slidably the large groove portion 119 of the slide groove 117. The engaging block 23 is connected to the tail segment 213 of the gear rack 21 and engages slidably the through groove 118 for preventing the gear rack 21 from being separated from the through groove 118, but may be omitted in other embodiments of this invention.

In this embodiment, the shade unit 3 includes a fabric shade 31, a plurality of slide blocks 32 and a plurality of spaced-apart hook members 33.

The fabric shade 31 is hung from the rail seat 11 and is disposed below the slide groove 117, and has a hanging edge portion 311 that is adjacent to the slide groove 117 and that extends in the longitudinal direction (L). The hanging edge portion 311 has a stationary end 312 that is coupled to the first end 111 of the rail seat 11, and a movable end 313 that is coupled co-movably to the guide block 22.

The slide blocks 32 engage and are movable along the slide groove 117, and are disposed between the first end 111 of the rail seat 11 and the guide block 22. Each of the slide blocks 32 has a slide part 321 engaging the large groove portion 119 of the slide groove 117 and that abuts slidably against the groove-defining walls 115, and a projecting part 322 extending downwardly from a center of a bottom end of the slide part 321 through the small groove portion 110 of the slide groove 117. In this embodiment, each of the slide blocks 32 has a T-shaped cross section to correspond in shape to the slide groove 117. The configuration of the slide blocks 32 and the groove-defining walls 115 may vary in other embodiments of this invention (for example, the slide part 321 of each slide block 32 may be formed as a ball) in order to minimize friction therebetween.

The hook members 33 are hung respectively from the slide blocks 32. Each of the hook members 33 is C-shaped, and has a threading portion 331 threading through the hanging edge portion 311 of the fabric shade 31, and a hanging portion 332 hung from the projecting part 322 of a respective one of the slide blocks 32.

The driving mechanism 4 is retained in the end seat 12 of the mounting unit 1, and includes a pinion 41 meshing rotatably with the gear rack 21, a power unit 42 for driving rotation of the pinion 41, and an idler wheel 43. The middle segment 212 of the gear rack 21 meshes slidably with and passes over the pinion 41. The power unit 42 includes a motor 421, a worm 422 driven rotatably by the motor 421, and a worm gear 423 connected co-rotatably to the pinion 41 and meshing rotatably with the worm 422. The idler wheel 43 is disposed rotatably under the pinion 41 for supporting the middle segment 212, such that the middle segment 212 of the gear rack 21 is clamped slidably between the pinion 41 and the idler wheel 43.

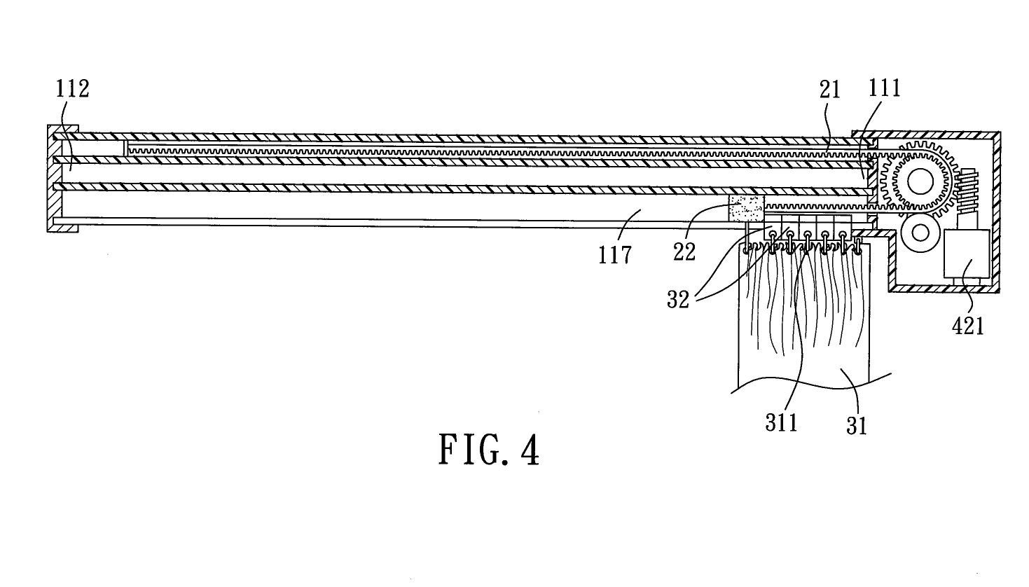

In use, the worm gear 423 is driven to rotate together with the pinion 41 by the motor 421 through the worm 422, thereby resulting in sliding movements of the head segment 211 and the tail segment 213 of the gear rack 21 in the slide groove 117 and the through groove 118 in the longitudinal direction, respectively. The guide block 22 is consequently moved together with the head segment 211 of the gear rack 21 along the slide groove 117, thereby driving the fabric shade 31 to move relative to the rail seat 11 between a contracted state (see FIG. 4) and an extended state (see FIG. 1). When the fabric shade 31 is at the contracted state, the guide blocks 22 are gathered together and disposed adjacent to the first end 111 of the rail seat 11. When the fabric shade 31 is converted from the contracted state to the extended state, the guide blocks 22 are driven to spread out along the slide groove 117. During the movement of the fabric shade 31 between the contracted state and the extended state, the motor 421 can be stopped to terminate the operation of the fabric shade 31 whenever the fabric shade 31 is moved to a desired position.

Therefore, a user can simply control the driving mechanism 4 to operate all the electric sunshade assemblies of the invention that may be mounted on different side windows of an automobile. Compared to the previously mentioned conventional sunshade assembly, the operation of the electric sunshade assembly of this invention is relatively convenient.

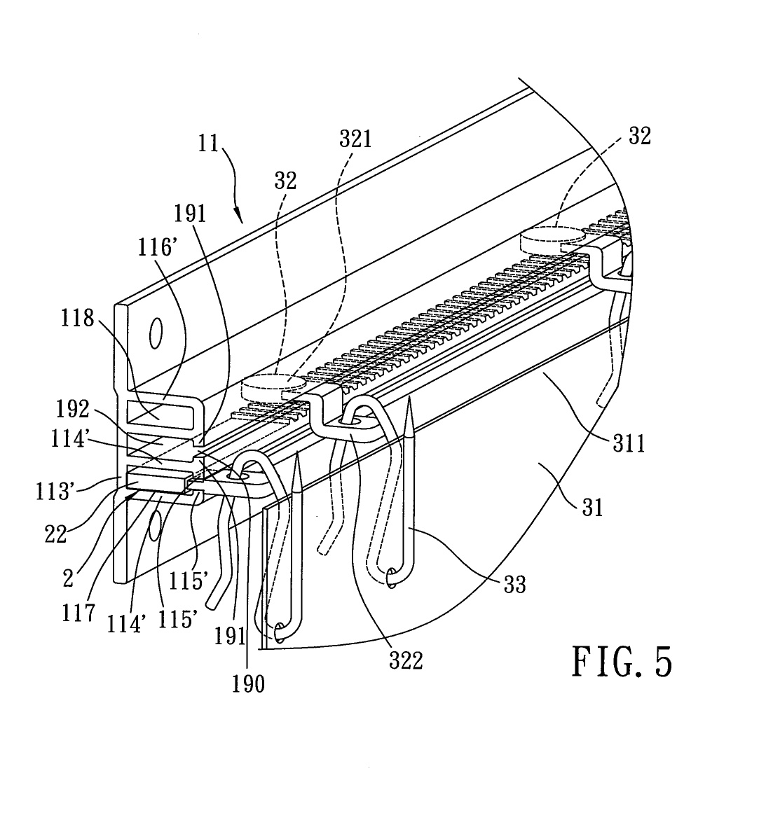

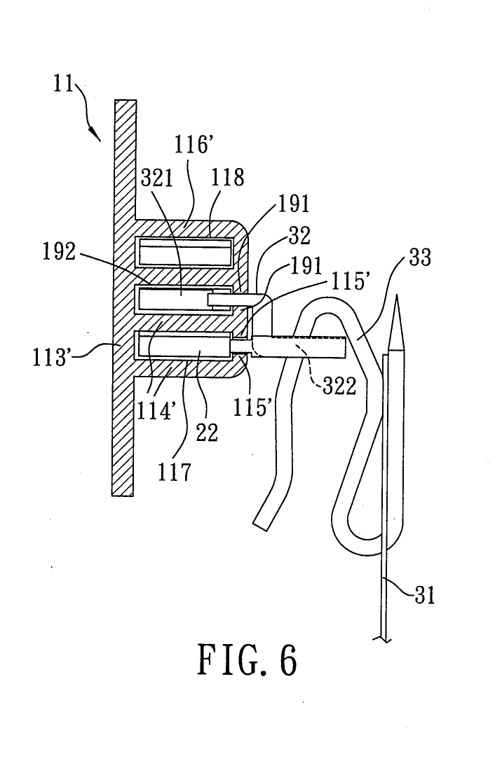

As shown in FIGS. 5 and 6, the second preferred embodiment of the electric sunshade assembly according to the present invention has a structure similar to that of the first embodiment. The main difference between this embodiment and the previous embodiment resides in the following.

In this embodiment, the rail seat 11 includes a vertical base wall 113′, a pair of spaced-apart side walls 114′ extending horizontally from the base wall 113′, and a pair of groove-defining walls 115′ extending respectively from distal edges of the side walls 114′ toward each other. The groove-defining walls 115′ cooperate with the base wall 113′ and the side walls 114′ to define the slide groove 117 thereamong. The rail seat 11 further includes a tubular wall 116′ and a pair of limit walls 191. The tubular wall 116′ is disposed over the side walls 114′, is connected to the base wall 113′ and defines the through groove 118 therein. One of the limit walls 191 extends upwardly from the distal edge of an upper one of the side walls 114′, and the other one of the limit walls 191 extends downwardly from a front end of the tubular wall 116′ toward the one of the limit walls 191 and cooperates with the one of the limit walls 191 to define a gap 190 therebetween. The limit walls 191 cooperate with the base wall 113′, the upper one of the side walls 114′ and the tubular wall 116′ to define a receiving groove 192 between the slide groove 117 and the through groove 118. The slide part 321 of each slide block 32 engages slidably the receiving groove 192, and the projecting part 322 of each slide block 32 extends from the slide part 321 of a corresponding slide block 32 out of the receiving groove 192 through the gap 190 between the limit walls 191. Each of the hook members 33 is substantially S-shaped in this embodiment. Therefore, the slide blocks 32 can slide smoothly in the receiving groove 192 without being interfered by the sliding movement of the guide block 22 in the slide groove 117.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electric sunshade assembly comprising:
a mounting unit including a rail seat having first and second ends that are opposite to each other in a longitudinal direction, and formed with a slide groove that extends therethrough from said first end to said second end;
a sliding unit including a gear rack that has an end extending slidably into said slide groove from said first end of said rail seat, and a guide block that engages fittingly and slidably said slide groove and that is connected to said end of said gear rack;
a shade unit including a fabric shade that is hung from said rail seat and that is disposed below said slide groove, said fabric shade having a hanging edge portion that is adjacent to said slide groove and that extends in the longitudinal direction, said hanging edge portion having a stationary end that is coupled to said first end of said rail seat, and a movable end that is coupled co-movably to said guide block; and
a driving mechanism including a pinion that meshes rotatably with said gear rack, and a power unit for driving rotation of said pinion;
wherein said pinion is driven rotatably by said power unit to result in sliding movement of said end of said gear rack in said slide groove in the longitudinal direction, thereby driving said shade fabric to move relative to said rail seat between a contracted state, where said guide block is close to said first end of said rail seat, and an extended state, where said guide block is close to said second end of said rail seat.

2. The electric sunshade assembly as claimed in claim 1, wherein said power unit includes a motor, a worm driven rotatably by said motor, and a worm gear connected co-rotatably to said pinion and meshing rotatably with said worm.

3. The electric sunshade assembly as claimed in claim 1, wherein:
said rail seat is further formed with a through groove parallel to and disposed over said slide groove; and
said gear rack is configured as a flexible elongated rack, and has
a head segment disposed slidably in said slide groove, and formed with said end that is connected to said guide block,
a middle segment extending outwardly of said slide groove from said head segment, meshing slidably with and passing over said pinion, and further extending into said through groove, and
a tail segment extending from said middle segment and disposed slidably in said through groove.

4. The electric sunshade assembly as claimed in claim 2, wherein:
said rail seat is further formed with a through groove parallel to and disposed over said slide groove; and
said gear rack is configured as a flexible elongated rack, and has
a head segment disposed slidably in said slide groove, and formed with said end that is connected to said guide block,
a middle segment extending outwardly of said slide groove from said head segment, meshing slidably with and passing over said pinion, and further extending into said through groove, and
a tail segment extending from said middle segment and disposed slidably in said through groove.

5. The electric sunshade assembly as claimed in claim 3, wherein said driving mechanism further includes an idler wheel disposed rotatably adjacent to said pinion, said gear rack being clamped slidably between said pinion and said idler wheel.

6. The electric sunshade assembly as claimed in claim 3, wherein said shade unit further includes:
a plurality of slide blocks engaging and movable along said slide groove; and
a plurality of spaced-apart hook members hung respectively from said slide blocks and threading through said hanging edge portion of said fabric shade between said stationary end and said movable end thereof.

7. The electric sunshade assembly as claimed in claim 6, wherein:
said rail seat includes
a horizontal base wall,
a pair of side walls extending downwardly and respectively from front and rear edges of said base wall,
a pair of groove-defining walls extending respectively from bottom edges of said side walls toward each other, and cooperating with said base wall and said side walls to define said slide groove thereamong, and
a tubular wall connected to a top end of said base wall and defining said through groove therein;
said slide groove has a large groove portion and a small groove portion smaller than, formed under and communicating spatially with said large groove portion, said guide block engaging fittingly and slidably said large groove portion of said slide groove;
said slide blocks are disposed between said first end of said rail seat and said guide block, each of said slide blocks having a slide part that engages said large groove portion of said slide groove and that abuts slidably against said groove-defining walls of said rail seat, and a projecting part that extends downwardly from a bottom end of said slide part through said small groove portion of said slide groove; and
each of said hook members has a threading portion threading through said hanging edge portion of said fabric shade, and a hanging portion hung from said projecting part of a respective one of said slide blocks.

8. The electric sunshade assembly as claimed in claim 6, wherein:
said rail seat includes
a vertical base wall,
a pair of spaced-apart side walls extending horizontally from said base wall,
a pair of groove-defining walls extending respectively from distal edges of said side walls toward each other, and cooperating with said base wall and said side walls to define said slide groove thereamong,
a tubular wall disposed over said side walls, connected to said base wall and defining said through groove therein, and
a pair of limit walls, one of said limit walls extending upwardly from said distal edge of an upper one of said side walls, the other one of said limit walls extending downwardly from a front end of said tubular wall toward said one of said limit walls and cooperating with said one of said limit walls to define a gap therebetween, said limit walls cooperating with said base wall, the upper one of said side walls and said tubular wall to define a receiving groove thereamong;
said slide blocks are disposed between said first end of said rail seat and said guide block, each of said slide blocks having a slide part that engages said receiving groove, and a projecting part that extends from said slide part out of said receiving groove through said gap between said limit walls; and
each of said hook members has a threading portion threading through said hanging edge portion of said fabric shade, and a hanging portion hung from said projecting part of a respective one of said slide blocks.

9. The electric sunshade assembly as claimed in claim 1, wherein said mounting unit further includes an end seat coupled to said first end of said rail seat for retaining said driving mechanism therein, and an end cover coupled to said second end of said rail seat for closing an end of said slide groove at said second end of said rail seat.
